(19) United States
(12) Patent Application Publication
(10) Pub. No.: US 2010/0196234 A1
(43) Pub. Date: Aug. 5, 2010

(54) METHOD FOR SEPARATING CARBON DIOXIDE FROM FLUE GASES AND ASSOCIATED DEVICE

(76) Inventors: Thomas Hammer, Hemhofen (DE); Werner Hartmann, Weisendorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/665,120

(22) PCT Filed: Jun. 27, 2008
(86) PCT No.: PCT/EP2008/058240

§ 371 Date: Dec. 17, 2009

(30) Foreign Application Priority Data
Jun. 29, 2007 (DE) 10 2007 030 069.9

(51) Int. Cl. B01D 53/62; B01D 53/86; B01J 8/00; C01B 31/20

(52) U.S. Cl. 423/230; 422/178

(57) ABSTRACT

A method in which CO₂ is placed on an adsorber and an adsorption reaction with ammonia, that is used as a chemical absorption agent, occurs, is provided. The CO₂ extracted from the waste gas is joined to the ammonia on the catalytic surface using a heterogeneous, catalytic reaction. At least two reactors are provided in the associated device. The reactors, which operate alternately, are switched between the adsorption of CO₂ and the regeneration of the absorption agent.

### CROSS REFERENCE TO RELATED APPLICATIONS

This application is the US National Stage of International Application No. PCT/EP2008/058240, filed Jun. 27, 2008 and claims the benefit thereof. The International Application claims the benefits of German application No. 10 2007 030 069.9 DE filed Jun. 29, 2007, both of the applications are incorporated by reference herein in their entirety.

### FIELD OF INVENTION

The invention relates to a method for separating carbon dioxide (CO₂) from flue gases by using an adsorption method, wherein the CO₂ is accumulated on an adsorber. In addition, the invention relates to an associated device for executing the method.

### BACKGROUND OF INVENTION

The reduction in the emission of the greenhouse gas carbon dioxide (CO₂) from power plants and industrial plants can be achieved through the use of low-carbon fuels.

The latter is however not a solution for existing plants which are designed to use high-carbon fuels, such as lignite-fired power plants in particular. Separation processes are required here which remove the CO₂ for example from the flue gas, or the waste gas.

All the gases arising during the combustion process are referred to as flue gases, whereby the expression waste gas is used throughout in the following.

The removal of CO₂ from waste gas can take place by means of physical or/or chemical binding in the bulk (“absorption”) or by means of accumulation on active surfaces (“adsorption”).

With regard to the physical or chemical absorption, in both cases these are multi-step processes in which the waste gas containing CO₂ is brought into contact with a physical or chemical absorber until the latter is completely charged with CO₂. Thereafter the absorber must be discharged, whereby the CO₂ is released in the presence of a scrubbing gas and is finally separated from the absorber.

Potential problems in this situation are the slippage of the substance required for the binding, in other words the absorber, the separation of the CO₂ from the scrubbing gas in a form which permits the further use of the CO₂, and where applicable the high energy requirement for the regeneration, particularly in the case of chemical binding.

The binding of CO₂ by means of ammonia has recently been proposed, a method that has long been known from the synthesis of ammonia (see Parrish, Roger Warren: “Process for manufacture of ammonia”, EP 0247 220 B1 and the publication cited therein Uhde, Georg Friedrich: “Method of separating ammonia from gases and mixtures of gases containing ammonia”, U.S. Pat. No. 1,745,730 A), whereby ammonia slip can occur in the case of the separation of CO₂ from waste gas, and moreover the separation of CO₂ and NH₃, which is present in bound form as ammonium carbonate or ammonium hydrogen carbonate, presents problems.

Alternatively, it is possible to work with adsorbers, on which the CO₂ is accumulated in a first process step for example at low temperature or high pressure and is desorbed in a second process step at high temperature or low pressure (so-called “pressure swing adsorption” or “temperature swing adsorption”). A problem regarding the level of efficiency exists here because the adsorption capacity is considerably less than the capacity of absorbers, whereby a high energy requirement results in order to be able to handle temperature and pressure cycles.

A method is described in DE 1 911 670 A for cleaning gases which contain acidic components such as CO₂, whereby here as well as in the following three publications the further use of the cleaned gas is the primary objective and not the further use of the gas bound on an adsorber. The separation of CO₂ from process gases for the semiconductor industry by means of adsorption on zeolites charged with ammonia is known from JP 04-022415, whereby the CO₂ remains chemically bound at ambient temperature through reaction with the ammonia. The separation of CO₂ from waste gases, for example from thermal power plants, through carbonation at temperatures between 600° C. and 800° C., is described in JP 10-272336 A. Finally, it is demonstrated in a paper published from “Applied Surface Science”, Vol. 225, No. 1-4, pp. 235-242 (2004) that a preparation of activated carbon using ammonia leads to improved binding of CO₂. In none of the cases is a method disclosed which enables the CO₂ removed from the gas undergoing cleaning to be prepared for further use or disposal with a justifiable expenditure of energy.

In addition, membrane methods for separating CO₂ are possible which hitherto however have been unsuitable for applications in large plants for reasons of cost and efficiency level, in other words the low selectivity of the separation process between CO₂ and for example N₂.

### SUMMARY OF INVENTION

Starting from this basis, the object of the invention is to propose an improved method for the large-scale reduction in emissions of carbon dioxide (CO₂) and to create an associated device. In this situation, the CO₂ should be separated from the waste gases such that the subsequent use for disposal of the CO₂ is made possible.

This object is achieved in respect of the method by the measures described in the claims, whereby the invention emerges as a sequence of individual process steps. An associated device is the subject matter of the claims. Developments of the method and the associated device are set down in the respective dependent claims.

According to the invention it is proposed that the binding of CO₂ from waste gas be performed in an adsorption reactor by means of a heterogeneous catalytic reaction with ammonia as the chemical absorber which is bound to the catalytic surface. In this situation, the process is conducted at a low temperature T with the result that the reaction products containing carbon, such as isocyanic acid (HNCO) and urea ((NH₂)₂CO) for example, are also bound to the catalytic surface in accordance with the following reaction equations, whereby the molecules bound to the catalytic surface are identified by an “s”:

NH₃(s)+CO₂⇄HNCO(s)+H₂O (1)

HNCO(s)+NH₃(s)⇄(NH₂)₂CO(s) (2)

A suitable temperature window is dependent on the catalyst used, in particular at temperatures below T=200° C., and in the case of the invention is advantageously:

70° C.<T<140° C. (1a)

At low temperatures and high surface concentrations of NH₃ the equilibrium of the reaction (2) lies on the right-hand side of the reaction equation, at high temperatures or low surface concentrations of NH₃ however on the left-hand side.

The catalyst is subsequently regenerated, whilst excluding the waste gas, at a higher temperature in a gas mixture consisting of water vapor and CO₂, whereby CO₂ is selectively released and is thereby definitively separated, while the absorption agent is returned to its original state and remains bound to the surface in this situation:

HNCO(s)+H₂O→NH₃(s)+CO₂ (3)

Reaction (3) represents the converse of the reaction (1), which is forced to take place as a result of the fact that water vapor is made available in excess and the temperature is raised such that it lies above the window specified in (1a). As a result the equilibrium of the reaction (2) is shifted to the left-hand side because isocyanic acid (HNCO) is constantly eliminated through the hydrolysis reaction (3).

The subsequent separation of water vapor and CO₂ can be achieved through condensation by means of suitable pressure and temperature control.

Alternative reaction mechanisms, which for example lead to the formation of ammonium carbamate NH₂CO₂⁻NH₄⁺, can likewise be represented when suitable reaction parameters (low temperature) and catalysts are chosen:

2NH₃(s)+CO₂→NH₂CO₂⁻NH₄⁺(s) (4)

Ammonium carbamate (NH₂CO₂NH₄⁺) can be converted to ammonium carbonate by hydrolysis in an aqueous solution or on a suitable catalytic surface even at low temperatures:

NH₂CO₂⁻NH₄⁺(s)+H₂O→(NH₄)₂CO₃ (5)

The ammonium carbonate decomposes thermally on an increase in temperature into NH₃ and CO₂ and water is split off:

(NH₄)₂CO₃→2NH₃(s)+CO₂+H₂O (6)

By using suitable catalysts it is possible to ensure that NH₃ remains bound on the surface. The subsequent separation of water vapor and CO₂ can again be achieved through condensation by means of suitable pressure and temperature control.

With regard to the device according to the invention, at least two reactors are present. In this situation, for the purposes of execution of the inventive method described above in terms of flow implementation it is possible to implement the following as different arrangements:
Two parallel reactors are fed alternately with waste gas for the adsorption of the CO₂ and the respective working reactor is taken out of the waste gas stream when the adsorber has been largely converted and fed with the regeneration gas which has been brought to the required temperature.
One adsorption reactor and one regeneration reactor are located parallel to one another such that the catalyst required for the reaction process can be guided through a gas lock from the adsorption reactor into the regeneration reactor and back.

One option for the latter is to design the catalyst for example as a rotatable stack of disks which is arranged such that the catalytic surfaces alternately pass through the adsorption reactor and the regeneration reactor. As an alternative to this, the passage of catalyst particles in counterflow is possible.

The advantages of the invention described above compared with the previous methods, which function with liquids such as ammonia in aqueous solution, lie essentially in the fact that by choosing suitable catalysts with binding sites for NH₃ the ammonia slip can be greatly reduced. In addition, the reaction kinetics can as a result be configured considerably more selectively, such that the formation of undesired byproducts is suppressed, which consume the absorber or result in a binding of the CO₂ which is energetically strong and can be released only with a high expenditure of energy.

It is furthermore advantageous that a considerable portion of the CO₂ from waste gases is separated in such a form which enables the subsequent use of the CO₂ with a low expenditure of energy in order to arrive at a sustainable reduction in CO₂ emissions.

By preference, oxides and mixtures of oxides such as TiO₂ and V₂O₅ for example come into consideration as catalytic materials, whereby titanium dioxide for example is a suitable hydrolysis catalyst, while V₂O₅ is favorable for binding ammonia on the surface. Alternatively, ion exchanged zeolites can be employed as catalysts, which are likewise capable of binding ammonia very selectively.

Use of the method according to the invention is of particular interest with regard to CO₂ separation by way of ammonia solutions at process temperatures >10° C. since in this case a proportion of NH₃, dependent on temperature, in the region of several percent by volume, is still present in the separated CO₂, which cannot be eliminated economically by conventional methods.

### BRIEF DESCRIPTION OF THE DRAWINGS

Further details and advantages of the invention will emerge from the following description of figures for exemplary embodiments with reference to the drawing in conjunction with the claims.

In schematic representation in the drawings:

FIG. 1 shows an arrangement for separating CO² from waste gas with the aid of a solid catalyst and

FIG. 2 shows an alternative arrangement to FIG. 1 with a rotatably arranged plate-type catalyst,

FIG. 3 shows a further arrangement with catalyst particles and

FIGS. 4 and 5 show the sensor system in the case of an alternating function of the reactors in accordance with the FIGS. 1 to 3 as an adsorption reactor on the one hand or as a desorption reactor on the other hand.

### DETAILED DESCRIPTION OF INVENTION

In the following, the two figures are described individually in each case. In this situation the essential elements, such as the reactors and valves including the lines which comprise the same function have the same reference characters.

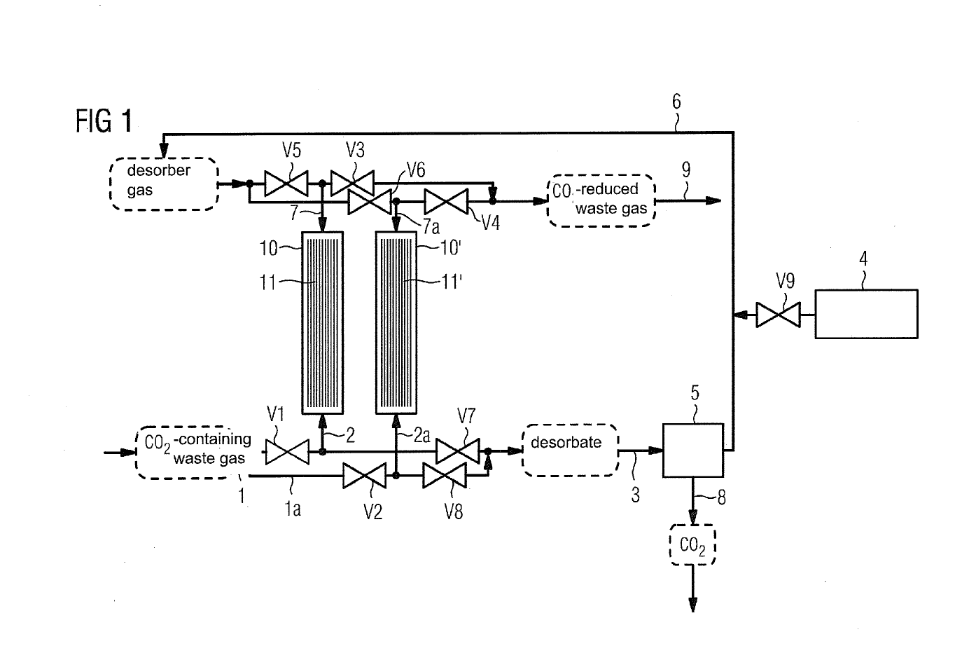

With regard to the FIGS. 1 to 3, two identical reactors 10 and 10′, 20 and 20′, and 30 and 30′ respectively are present in each case, which are run in alternating operation. In other words, for example for

FIG. 1, while the one of the two reactors 10, 10′ is used for the adsorption of the CO₂ in the waste gas containing CO₂, the other of the two reactors 10, 10′ is discharged, which is described in detail further below. For such a type of alternating operation, fluid lines with a series of valves are required as well as additionally a storage container for an absorption agent for CO₂ and a unit for separating the CO₂ from the regenerate.

The two reactors 10 and 10′ in FIG. 1 each have a respective catalyst bed 11 and 11′. Waste gas containing CO₂ is delivered by way of a waste gas line 1 and directed by way of the branch 2 either into the first reactor 10 or by way of a parallel line la with branch line 2a into the second reactor 10′ connected in parallel. Valves V1, V2, V7 and V8 are connected into the lines 1, 1a for this purpose. The associated control unit is not shown.

At any one time one of the reactors 10, 10′ is therefore in adsorption operation while the other reactor is in regeneration operation. To this end, a reaction gas mixture, which is also referred to as regenerate, is fed from the other side of the reactors by way of the line 6 with the parallel line 6a and the respective branch lines 7 and 7a to the two reactors in alternating operation. For this purpose, valves V3, V4, V5 and V6, whose function emerges from the description of the alternating operation, are connected in the lines 6, 6a. CO₂-reduced waste gas is taken away by way of the line 8 and regenerate containing CO₂ is delivered to the unit 5 by way of the line 3. The separation of CO₂ from the regenerate takes place in the unit 5, with the result that pure recovered CO₂ is taken away here. The container for the absorption agent is designated by 4 and is operatively connected by way of a valve V9 to the fluid circuit.

The two reactors 10, 10′ in FIG. 1 have—as already mentioned—catalyst beds 11 and 11′ which contain a solid catalyst, which is designed for example as a plate-type catalyst. Alternatively, such a catalyst bed can also be designed as a so-called particle bed (“packed bed”).

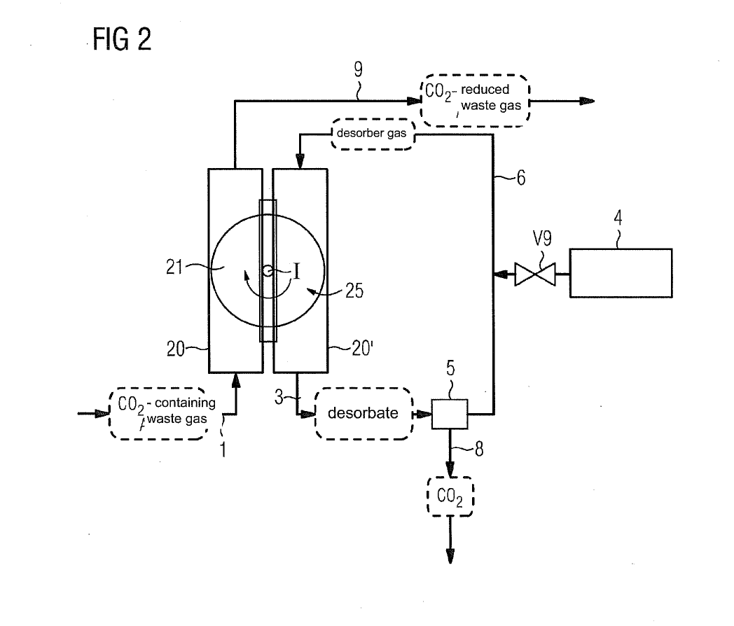

FIG. 2 shows a simplified illustration of an alternative arrangement to FIG. 1, having reactors 20 and 20′. The individual valves are not shown here, apart from valve V9. In this situation, the two reactors 20, 20′ are connected to each other by way of a gas-tight lock. Instead of the catalyst beds from. FIG. 1, plate-type catalysts 15 are present here, arranged rotatably around a vertical axis. Both reactors are linked by way of a gas-tight lock 30, whereby through rotation of the catalyst plate arrangement in each case a fully charged catalyst half can be brought into the second reactor for generation purposes and the discharged catalyst plate half is available for recharging. Otherwise, the alternation principle with delivery of a regeneration gas mixture (“regenerate”) on the one hand and separation (CO₂) on the other hand from the waste gas is identical. It is important in both cases that absorption agent can be added in regulated fashion to the regenerator after the CO₂ separation in order to compensate for an unavoidable loss of regeneration agent occurring during practical operation.

Other embodiments according to the invention include plate reactors coated with catalysts, in particular those having movable plates or other structures having a large specific surface, in which the plates are transported in a rotary fashion from the charging area (flue gas, CO₂ gas stream) by way of a lock system into the discharging area for CO₂ separation purposes and back into the charging area.

In deviation to the FIGS. 1 and 2, the invention defined on the basis of the application for protection also includes arrangements in which the gas stream to be cleaned is passed through a fluidized bed of small catalyst particles (“fluidized bed reactor”), whereby in particular small particles and those having a high specific surface, for example porous particles, are advantageous. The charged particles are continuously removed from the charging area, delivered to a desorption area and then fed back again into the adsorption reactor.

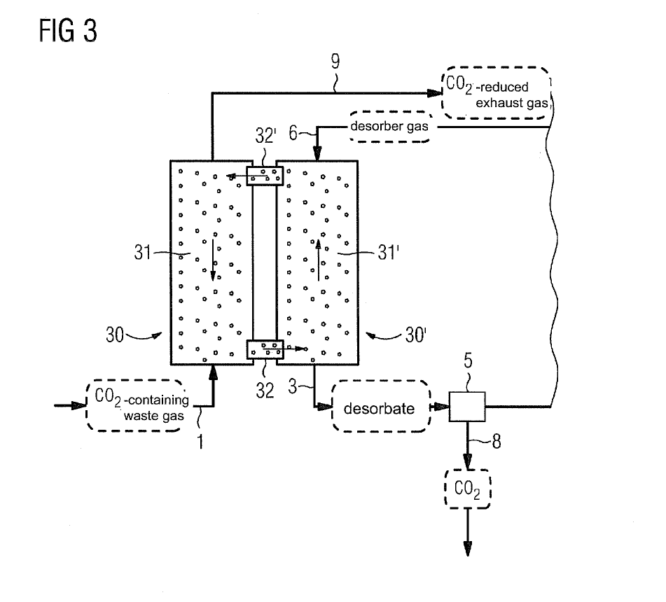

In the simplified illustration according to FIG. 3, in a further arrangement the gas stream to be cleaned is delivered in counterflow through a “shower” of catalyst coated particles having a high specific surface (“trickle-bed reactor”), whereby the charged particles are likewise continuously removed, regenerated and delivered back again to the trickle-bed reactor.

To this end, two reactors 30 and 30′ are shown in FIG. 3, which operate on the counterflow principle. In this situation, both reactors 30, 30′ have catalyst plates 31 and 31′ respectively, which are implemented in each case as a packed bed of catalytic particles. Both reactors 30 and 30′ are connected at their ends in each case by means of a gas-tight lock 32 and 32′ respectively.

Otherwise, the device according to FIG. 3 operates in corresponding fashion to FIG. 2. It is however important here that the waste gas containing CO₂ is brought into the reactor 30 by way of the line 1 and flows there in counterflow to the catalyst particles. Corresponding conversely, the regenerate is brought into the reactor 30′, whereby the catalyst particles here flow again in counterflow according to the arrow. In practice, a through-flow pump is used for this purpose, which is not shown individually in FIG. 3.

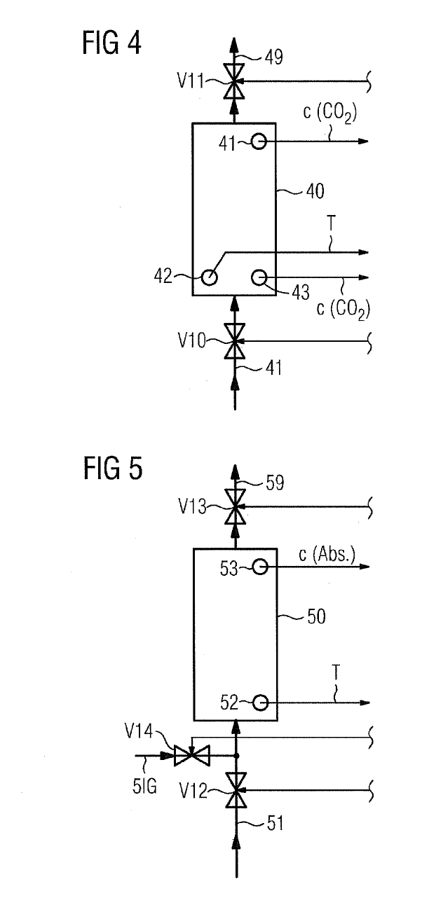

The sensor system on the one hand and also the signal processing are not contained in the examples illustrated in FIGS. 1 to 3. Essentially it is the same for all the three examples according to FIGS. 1 to 3 and is explained in detail with reference to FIGS. 4 and 5.

In FIG. 4, an adsorption reactor is designated all-inclusively by 40. A valve V10 is provided for the flue gas inlet by way of a line 41 and a valve V11 is provided for the gas take-off at the outlet from the reactor by way of the line 49. A temperature sensor 42 and also a gas sensor 43 for the CO₂ concentration are situated on the input side in the adsorption reactor 40. A further gas sensor 44 for the CO₂ concentration is present on the outgoing side. It is therefore important that the concentrations c(CO₂) at the input on the one hand and at the output on the other hand can be measured and are correlated with the temperature T in accordance with a thermally activated process. The adsorption capacity of the adsorber can be determined from the decrease in the CO₂ concentration at a particular temperature T. When the adsorption capacity decreases below a particular limit value a regeneration is initiated.

In FIG. 5, a desorption reactor 50 is illustrated which has input lines 51, 51a and an output line 59. Valves V12 and V13 are again provided at the input and at the output, and a valve V14 is additionally provided in the feed line 51a for delivering an absorption agent.

In the desorption reactor 50, a sensor 52 is provided at the input for the temperature T and a sensor 53 is provided at the output for the concentration c(Abs) of the absorption agent. The signals for the concentrations on the one hand and the temperatures on the other hand are processed in a control device which is not described individually, a known microprocessor control unit for example. An important criterion concerning the control in this situation is the fact that the adsorption capacity of the catalytic material for CO₂, which is determined from current CO₂ measurement values at the adsorption reactor, is maintained in an adequate manner through the storage of absorption agent on the catalytic surface. For this purpose, a valve V12 is closed in order to stop the delivery of desorption gas mixture. Valve V14 is then opened in order to deliver absorption agent (ammonia for example). Shortly thereafter valve V13 is closed in order to avoid any slip of the absorption agent. As soon as the sensor 53 in the output area of the desorption reactor 50 identifies absorption agent concentrations above a first limit value, valve V14 is closed.

During operation of the device as intended, temperature T and absorption agent concentration c(Abs) are monitored by sensors: As the temperature T drops, with an intact catalyst the storage capacity for the absorption agent rises such that the concentration c(Abs) of the absorption agent still contained in the gas phase falls below a second limit value classed as uncritical after a short waiting time and the reactor, or the catalyst charged with absorption agent, can be taken into operation again. Deviations from this behavior give indications of damage to the catalyst as a result of either mechanical, thermal or also chemical influences, whereby maintenance of the system can be undertaken where necessary.

The devices having two reactors described with reference to the figures can advantageously be used for separating CO₂ from waste gases containing CO₂. In this situation, the following process steps in particular take place:
The waste gas containing CO₂ is passed over a catalyst, at the active centers of which NH₃ is accumulated.
The CO₂ is transformed at a first process temperature by chemical reactions with the NH₃ into a stabile compound which is likewise bound to the catalyst surface. This temperature is designated T₁.
At a second process temperature which is higher than the first process temperature, the catalyst thus charged with CO₂ is subjected to a scrubbing gas stream consisting of CO₂ and water vapor (H₂O). This temperature is designated T₂ (T₂>T₁). At this temperature the compound comprising CO₂ and NH₃ decomposes, the CO₂ is given off into the scrubbing gas stream while the NH₃ remains accumulated on the surface of the catalyst.
The scrubbing gas stream enriched with CO₂ is conveyed into the further reactor and cooled down there to a temperature which is lower than the first process temperature. This temperature is designated T₃ (T₃<T₁). At this temperature the water is condensed and discharged.

As a result of this temperature control the pure dry CO₂ above the water surface can then be pumped away and delivered for a further use.

Overall, it can be noted that by using the method described above and also the devices created to implement the method the separation of CO₂ in particular from flue gases and in principle from CO₂-containing waste gases of all types takes place in a single manner. A reduction in the CO₂ emissions of climate damaging greenhouse gases is thereby made possible. It is important in this situation that the CO₂ is present at the end of the stated process in an almost pure form in order that it can be compressed for example for storage in natural gas fields or oil fields whilst simultaneously increasing the production volume (so-called “enhanced oil recovery”, “enhanced gas recovery”). Of secondary significance however is the completeness of the separation of the CO₂ from the flue gas: A residual quantity of 10% of the original CO₂ content can remain in the flue gas without further ado if as a result for example the energy requirement for the separation can be minimized compared with the energy turnover of the plant which is emitting the flue gas.

An oxidic catalyst is advantageously used as the adsorber for the plant. In this situation the catalyst consists for example of titanium oxide (TiO₂) or a mixture of titanium oxide (TiO₂) and a further metal oxide, in particular dosed with vanadium oxide (V₂O₅). It can also consist of an ion exchanged zeolite.

The desired objective of being able to produce carbon dioxide (CO₂) in pure form at the end of the process according to the invention for the purpose of further use or disposal can henceforth be achieved in an efficient manner.

1.-30. (canceled)

31. A method for separating carbon dioxide from waste gases using heterogeneous catalytic reactions of the carbon dioxide with ammonia, comprising:
passing a CO₂-containing waste gas over a catalyst, at the active centers of which NH₃ is accumulated;
transforming the CO₂ at a first process temperature by chemical reactions with the NH₃ into a stable compound which is likewise bound to a catalyst surface;
subjecting the CO₂ to a scrubbing gas stream consisting of CO₂ and water vapor at a second process temperature which is higher than the first process temperature, whereby the compound comprising CO₂ and NH₃ decomposes, the CO₂ is given off into the scrubbing gas stream, but the NH₃ remains accumulated on the catalytic surface;
conveying the scrubbing gas stream enriched with CO₂ into a further reactor and cooled down to a third temperature which is lower than the first process temperature, whereby the water condenses and is discharged; and
pumping away the pure dry CO₂ above a water surface and delivering the CO₂ for a further use.

32. The method as claimed in claim 31, wherein the first process temperature is below 200° C., with a result that reaction products containing carbon are also bound to the catalytic surface.

33. The method as claimed in claim 32, wherein the first process temperature lies in a range from 70° C. to 140° C.

34. The method as claimed in claim 32, wherein the binding to the catalytic surface takes place in accordance with the following reaction equations:
NH₃(s)+CO₂⇄HNCO(s)+H₂O as a first equation, and
HNCO(s)+NH₃(s)⇄(NH₂)₂CO(s) as a second equation,
whereby s identifies molecules bound to a surface of a catalytic adsorber.

35. The method as claimed in claim 34,
wherein an equilibrium of the reaction at low temperatures and high surface concentrations of NH₃ leads to a formation of urea in accordance with the second equation, and
wherein the equilibrium of the reaction at high temperatures or low surface concentrations of NH₃ is determined by the first equation and leads to a release of CO₂.

36. The method as claimed in claim 34, wherein an absorption agent is returned to an original state of the absorption agent when CO₂ is released, using water vapor, in accordance with the following reaction equations:
(NH₂)₂CO→NH₃(s)+HNCO(s) as a form of the second equation, and
HNCO(s)+H₂O→NH₃(s)+CO₂ as the third equation.

37. The method as claimed in claim 31, wherein using condensation, a combined pressure and temperature control unit is used for a separation of water vapor and CO₂.

38. The method as claimed in claim 31, wherein alternative reaction mechanisms are used for binding CO₂ which leads to a formation of ammonium carbonate (NH₂CO₂⁻NH₄⁺), in accordance with
2NH₃(s)+CO₂→NH₂CO₂⁻NH₄⁺(s) as a fourth equation.

39. The method as claimed in claim 38, wherein the ammonium carbonate is converted to ammonium carbonate by hydrolysis in an aqueous solution and/or on a suitable catalytic surface at low temperatures, in accordance with
NH₂CO₂⁻NH₄⁺(s)+H₂O→(NH₄)₂CO₃ as a fifth equation.

40. The method as claimed in claim 39, wherein the ammonium carbonate decomposes thermally on an increase in temperature into NH₃ and CO₂ and water is split off, in accordance with
(NH₄)₂CO₃→2NH₃(s)+CO₂+H₂O as a sixth equation.

41. The method as claimed in claim 31, wherein two reactors connected in parallel are used which are fed alternately with waste gas for the adsorption of the CO₂, and then when the adsorber has been mostly charged, the adsorber is taken out of a waste gas stream and fed with a desorption gas mixture which is at a required temperature.

42. The method as claimed in claim 31, wherein one adsorption reactor and one desorption reactor connected parallel to one another are used, whereby the catalyst required for a reaction process may be guided continuously through a gas lock from the adsorption reactor into the desorption reactor and back to the adsorption reactor.

43. The method as claimed in claim 42,
wherein a rotatable stack of a plurality of disks is used as the catalyst, and
wherein the rotatable stack of a plurality of disks is arranged such that a plurality of catalytic surfaces alternately pass through the adsorption reactor and the desorption reactor.

44. The method as claimed in claim 42,
wherein the catalyst is a packed bed of small particles including a large surface which are fed continuously to the adsorption reactor at a gas outlet,
wherein the catalyst is charged with CO₂ on a path through the adsorption reactor, and
wherein the catalyst is removed from the adsorption reactor again at the gas inlet by way of the gas lock and delivered for regeneration by desorption of CO₂.

45. The method as claimed in claim 31,
wherein an adsorption capacity of a catalytic material for CO₂ is maintained by a regeneration process, and
wherein ammonia is stored on the catalytic surface.

46. The method as claimed in claim 45, wherein the adsorption capacity of a catalytic material for CO₂ is monitored by a sensor.

47. The method as claimed in claim 45, wherein a charging of the catalyst with an absorption agent takes place in a separate process step following a CO₂ desorption, whereby firstly the scrubbing gas delivery is stopped using a suitable valve control, then the delivery of absorption agent is started, stopped again on reaching the charging limit and subsequently the reactor is completely separated from the gas circuit by closing the output-side valves, whereby the reaching of the charging limit is detected by an output-side gas sensor for the absorption agent

48. The method as claimed in claim 47, wherein a further concentration timing gradient of the absorption agent in the gas phase is detected by a plurality of sensors and is used for assessing an integrity of the catalytic adsorber.

49. A device including reactors to be used as an adsorber or a desorber of CO₂, comprising:
a first reactor used as an adsorber for a catalytic adsorption of CO_{2;}
a second reactor for the desorption of the CO₂ from the adsorber using a desorption gas mixture, and
a means for a disposal of a resulting desorbate;
a control unit to control the catalytic adsorption of the CO₂ from a waste gas containing CO₂ in the first reactor and for controlling the desorption of the CO₂ from a catalytic adsorber in the second reactor,
wherein the adsorber is the catalytic adsorber charged with an absorption agent with a high selectivity for the CO₂ adsorption reaction.

50. The device as claimed in claim 49, wherein the control unit controlling the gas streams with which the reactors are operated in each case in alternating operation between adsorption and desorption.
